(19) United States
(12) Patent Application Publication
(10) Pub. No.: US 2004/0192113 A1
(43) Pub. Date: Sep. 30, 2004

(54) Plug-in fuse-mounting structure

(75) Inventors: Takuro Yamashita, Shizuoka (JP); Norihiro Ohashi, Shizuoka (JP); Mitsuhiko Totsuka, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/806,418

(22) Filed: Mar. 23, 2004

(30) Foreign Application Priority Data
Mar. 24, 2003 (JP) P2003-080425

(51) Int. Cl. H01R 13/68

(52) U.S. Cl. 439/621

(57) ABSTRACT

A short plug-in fuse, having a fuse body received within an insulating housing, is fitted into a short fuse cavity of an electric connection box, so that the fuse body is connected to tab terminals projecting from an inner bottom surface of the fuse cavity. The short fuse cavity is set to a small fitting depth in corresponding relation to the short plug-in fuse, and a pair of guide grooves are formed in each of opposed inner side surfaces of the short fuse cavity, and extend in a fitting direction. A pair of guide ribs for respectively fitting into the corresponding pair of guide grooves are formed on each of parallel opposite outer side surfaces of the short plug-in fuse.

The present application is based on Japanese Patent Application No. 2003-80425, the entire contents of which are incorporated herein by reference.

### BACKGROUND OF THE INVENTION

1. Field of the Invention

This invention relates to a plug-in fuse-mounting structure, and more particularly to an improvement for preventing a short plug-in fuse from being erroneously fitted into a cavity for a long fuse.

2. Related Art

FIG. 4 shows one known conventional fuse cavity of an electric connection box in which an automotive fuse is adapted to be mounted (see; for example, JP-A-2000-325875).

This fuse cavity 40 includes a housing reception portion 41 having a tubular peripheral wall of a rectangular transverse cross-section, and a pair of tab terminals (serving as connection terminals) 43 and 44 project into the interior of the housing reception portion 41 through a bottom plate 42, and an upper end portion of the housing reception portion 41 is open, and serves as a fuse insertion port 45. The pair of tab terminals 43 and 44 are connected serially to a circuit within an electrical part mounted on a car body.

Examples of automotive fuses each for mounting in the fuse cavity 40 include plug-in fuses shown respectively in FIGS. 5 and 6.

The plug-in fuse 50, shown in FIG. 5, is a long plug-in fuse, and comprises an insulating housing 57, and a fuse body 58 received and held in the insulating housing 57. The insulating housing.57 has a cover portion 52 attached to an upper end of a housing body portion 51 of a square tubular shape (having a square transverse cross-section), and has a fitting opening portion 53 formed at a lower end of the housing body portion 51. The fuse body 58 includes a pair of tab-receiving terminals 54 and 55 for connection respectively to the tab terminals 43 and 44, and a fusible portion 56 integrally connected to the tab-receiving terminals 54 and 55 in overlying relation thereto. The cover portion 52 is locked to the housing body portion 51 by a pair of elastic lock piece portions (not shown).

The plug-in fuse 60, shown in FIG. 6, is a short plug-in fuse, and comprises an insulating housing 67, and a fuse body 68 received and held in the insulating housing 67. The insulating housing 67 has a cover portion 62 attached to an upper end of a housing body portion 61 of a square tubular shape (having a square transverse cross-section), and has a fitting opening portion 63 formed at a lower end of the housing body portion 61. The fuse body 68 includes a pair of tab-receiving terminals 64 and 65 for connection respectively to the tab terminals 43 and 44, and a fusible portion 66 integrally connected to the tab-receiving terminals 64 and 65 in overlying relation thereto.

A pair of elastic lock piece portions 62a and 62a are formed respectively at lower ends of opposed side walls of the cover portion 62, and these lock piece portions 62a and 62a can be retainingly engaged respectively with a pair of retaining projections 61a and 61a formed on the housing body portion 61.

Each of the plug-in fuses 50 and 60 is located in such a position that the fitting opening portion 53, 63 faces the fuse insertion port 45 in the fuse cavity 40, and then the housing body portion 51, 61 is inserted into the housing reception portion 41 until the fitting opening portion 53, 63 is brought into abutting engagement with the bottom plate 42, and by doing so, the tab-receiving terminals 54 and 55 (64 and 65) are electrically connected to the tab terminals 43 and 44, respectively.

In the event that short-circuiting occurs, for example, in an electrical part such as a motor, so that a large current flows through an associated circuit, the fusible portion 56, 66 of the plug-in fuse 50, 60 melts to interrupt the circuit so that the large current, exceeding an allowable value, will not flow through the circuit, thereby protecting the circuit.

Incidentally, in order that fuse cavities, provided at an electric connection box for an automobile, can be easily distinguished from the other cavities of this electric connection box for other circuit elements (such as relays) and that a fuse-mounting operation can be easily carried out, it is not desirable that many kinds of fuse cavities of different shapes and outer sizes are provided at the common electric connection box.

Therefore, the housing body portions 51 and 61 of the plug-in fuses 50 and 60 have the same transverse cross-sectional shape, and are different only in height from each other, while the housing reception portions 41 of the fuse cavities 40 of the electric connection box are different only in depth so that the fuse cavities can meet two kinds of (that is, long and short) plug-in fuses 50 and 60.

Thus, two kinds of (long and short) plug-in fuses 50 and. 60 can be suitably mounted merely by providing the housing reception portions 41 of different depths as described above. In this case, however, when the short plug-in fuse 60 is erroneously fitted into the housing reception portion 41 for the long plug-in fuse 50, the top of the plug-in fuse 60 is completely received within the housing reception portion 41, and therefore there is a possibility that this fuse can not be withdrawn from the housing reception portion, for example, when exchanging the fuse.

Particularly with a recent high-density mounting design of electric connection boxes, there is a tendency for fuses to be formed into a smaller size, and when the difference in height between a long plug-in fuse and a short plug-in fuse becomes smaller, it becomes more difficult to visually distinguish between the short fuse cavity and the long fuse cavity since these conventional short and long fuse cavities have the same transverse cross-sectional shape, and this leads to a possibility that the erroneous fitting occurs more frequently.

And besides, when the short plug-in fuse is formed into a small size, it becomes difficult to confirm its inserting direction when inserting it into the corresponding short fuse cavity, and there is a possibility that the short plug-in fuse is inserted in a wrong condition in which this fuse is turned 90 degrees, and as a result there is a fear that the connection terminals and the fuse body within the cavity are deformed.

It is therefore an object of this invention to solve the above problems and more specifically to provide a good plug-in fuse-mounting structure which prevents a short plug-in fuse from being erroneously fitted into a cavity for a long fuse.

### SUMMARY OF THE INVENTION

The above object of the invention has been achieved by a plug-in fuse-mounting structure comprising:

a plug-in fuse having an insulating housing and a fuse body received within the insulating housing; and

a fuse cavity into which the plug-in fuse is fitted and which includes connection terminals projecting from an inner bottom surface thereof,

wherein the fuse cavity has a small fitting depth in corresponding relation to a small height of the plug-in fuse, and at lease one guide groove is formed in an inner side surface of the fuse cavity so as to extend in a fitting direction of the plug-in fuse to the fuse cavity; and

a guide rib fitting into the guide groove is formed on an outer side surface of the plug-in fuse.

In the above construction, the short fuse cavity, formed at the electric connection box, is somewhat different in the shape of an opening from a long fuse cavity since the short fuse cavity has the guide groove. However, except the provision of the guide groove, the short and long fuse cavities are designed to have the same length and breadth (which are the basic dimensions of their transverse cross-sectional shape), so that these cavities maintain commonalities as fuse cavities, and therefore these fuse cavities never fail to be visually distinguished from the other cavities for other circuit elements (such as relay).

Even if trying to insert the short plug-in fuse into the long fuse cavity by mistake, the short fuse can not be inserted into the long fuse cavity because of the interference of the guide rib, and therefore the short plug-in fuse is positively prevented from being erroneously fitted into the long fuse cavity.

And besides, the guide rib is formed on the outer side surface of the short plug-in fuse, while the guide groove is formed in the inner side surface of the short fuse cavity, and therefore even when the fuse is formed into a small size, it is easy to confirm its inserting direction when inserting it into the corresponding short fuse cavity, and the short plug-in fuse is prevented from being inserted in a wrong condition in which this fuse is turned 90 degrees.

Furthermore, the short fuse cavity and the long fuse cavity are different from each other in transverse cross-sectional shape, and therefore the short fuse cavity and the long fuse cavity can be easily visually distinguished from each other even when the fuse is formed into a small size, and the efficiency of the fuse-mounting operation is enhanced.

Preferably, a pair of above-mentioned guide grooves are formed in each of opposed inner side surfaces of the short fuse cavity, and a pair of above-mentioned guide ribs are formed on each of opposite outer side surfaces of the short plug-in fuse corresponding respectively to the opposed inner side surfaces.

In this case, recesses, each formed between the corresponding pair of guide ribs, can serve as good positioning means when bringing a withdrawal jig into retaining engagement with the fuse, and this withdrawal jig can be guided into such a position that its axis coincides with the axis of the fuse, and therefore the withdrawal jig can be pulled up in a stable condition.

Another aspect of the invention is directed to a electrical connection box comprising:

a first plug-in fuse and a second plug-in fuse, wherein a height of the first plug-in fuse is smaller than a height of the second fuse and each of the first plug-in fuse and the second plug-in fuse has a common basic outer shape; and

a first fuse cavity and a second fuse cavity, wherein a depth of the first fuse cavity corresponds to the height of the first plug-in fuse and a depth of the second fuse cavity corresponds to the second plug-in fuse each of the first fuse cavity and the second fuse cavity has a basic cross-section;

wherein the fuse cavity has at lease one guide groove extends in a fitting direction of the plug-in fuse to the fuse cavity, and the first plug-in fuse has at least one guide rib for fitting into the guide groove.

By the above construction, plural kinds of plug-in fuses can be mounted reliably to the corresponding fuse cavities without erroneous fitting in the electric connection box.

Another aspect of the invention is directed to an erroneous fitting prevention method for plural kinds of plug-in fuses to fuse cavities, comprising:

providing a first plug-in fuse and a second plug-in fuse, wherein a height of the first plug-in fuse is smaller than a height of the second fuse and each of the first plug-in fuse and the second plug-in fuse has a common basic outer shape;

providing a first fuse cavity and a second fuse cavity, wherein a depth of the first fuse cavity corresponds to the height of the first plug-in fuse and a depth of the second fuse cavity corresponds to the second plug-in fuse each of the first fuse cavity and the second fuse cavity has a basic cross-section; and

fitting the first plug-in fuse into the first cavity; wherein the first fuse cavity has at lease one guide groove extends in a fitting direction of the plug-in fuse to the fuse cavity, and the first plug-in fuse has at least one guide rib for fitting into the guide groove, so that the first plug-in fuse is selectively fitted by the first fuse cavity and while the first plug-in fuse is not allowed to be fitted into the second fuse cavity.

By providing a guide rib on a plug-in fuse having a short height, it is possible to prevent the short plug-in fuse from inserted into wrong fuse cavity for longer plug-in fuses. Therefore, the problem that this fuse can not be withdrawn from the housing reception portion can be solved.

### BRIEF DESCRIPTION OF THE DRAWINGS

FIG. 1 is a perspective view showing an important portion of one preferred embodiment of a plug-in fuse-mounting structure of the invention;

FIG. 2 is a vertical cross-sectional view showing a condition in which a short plug-in fuse, shown in FIG. 1, is fitted in a short fuse cavity;

FIG. 3 is a vertical cross-sectional view showing a condition in which an attempt is made to fit the short plug-in fuse, shown in FIG. 1, into a long fuse cavity;

FIG. 4 is a partly-broken, perspective view of a fuse cavity portion of a conventional electric connection box in which a plug-in fuse is adapted to be mounted;

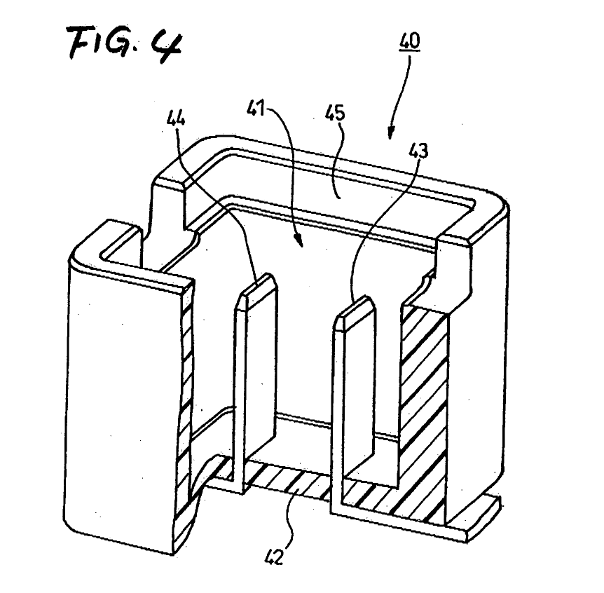

FIG. 5 is a cross-sectional view showing a condition in which a long plug-in fuse is mounted in the fuse cavity shown in FIG. 4; and

FIG. 6 is a cross-sectional view showing a condition in which a short plug-in fuse is mounted in the fuse cavity shown in FIG. 4.

### DETAILED DESCRIPTION OF THE PREFERRED EMBODIMENTS

One preferred embodiment of a plug-in fuse-mounting structure of the present invention will now be described in detail with reference to the accompanying drawings.

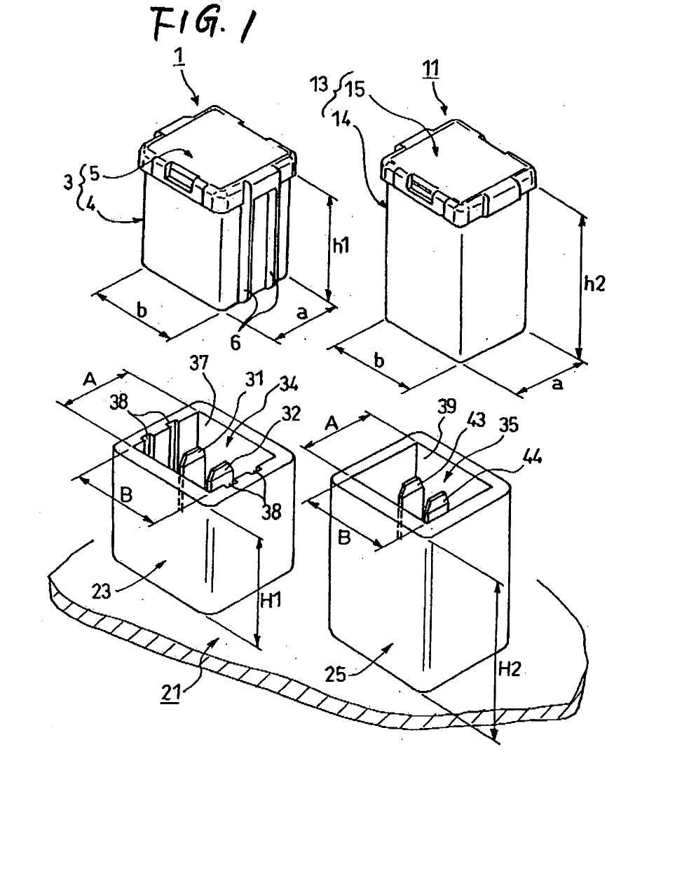

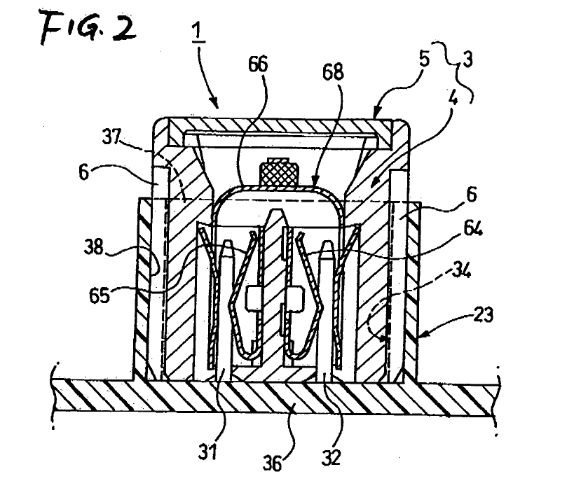

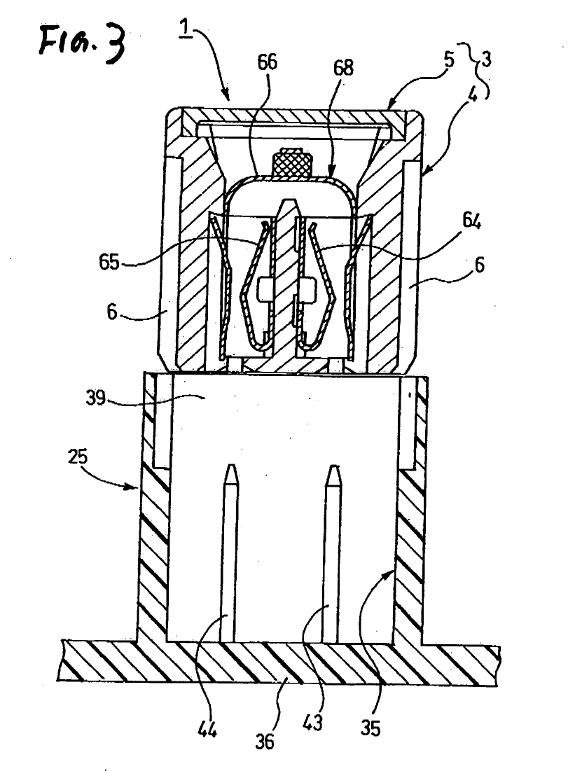

FIG. 1 is a perspective view showing an important portion of one preferred embodiment of the plug-in fuse-mounting structure of the invention, FIG. 2 is a vertical cross-sectional view showing a condition in which a short plug-in fuse, shown in FIG. 1, is fitted in a short fuse cavity, and FIG. 3 is a vertical cross-sectional view showing a condition in which an attempt is made to fit the short plug-in fuse, shown in FIG. 1, into a long fuse cavity.

In the plug-in fuse-mounting structure of this embodiment, each short plug-in fuse 1 and each long plug-in fuse 11 are inserted respectively into their corresponding short fuse cavity 23 and long fuse cavity 25 of an electric connection box 21, so that a fuse body 68, 58 of each of these fuses 1 and 11 is connected to tab terminals (connection terminals) 31 and 32 (43 and 44) projecting from a bottom portion 36 of the corresponding (short/long) fuse cavity 23, 25, as shown in FIGS. 1 and 2.

Each of the short and long plug-in fuses 1 and 11 has the fuse body 68, 58 incorporated in an insulating housing 3, 13.

The insulating housings 3 and 13 include housing body portions 4 and 14 of a square tubular shape (having a square transverse cross-section), respectively, and covers 5 and 15 are attached respectively to upper ends of the housing body portions 4 and 14. As shown in FIG. 1, the housing body portions 4 and 14 have the same length a and breadth b (which are the basic dimensions of their transverse cross-sectional shape), but have different heights h1 and h2, respectively.

A pair of guide ribs 6 and 6 are formed on a generally central portion of each of parallel opposite outer side surfaces of the housing body portion 4 of the short plug-in fuse 1, and extend in the direction of fitting of the fuse 1 into the fuse cavity 23. These guide ribs 6 are not formed on the housing body portion 14 of the long plug-in fuse 11.

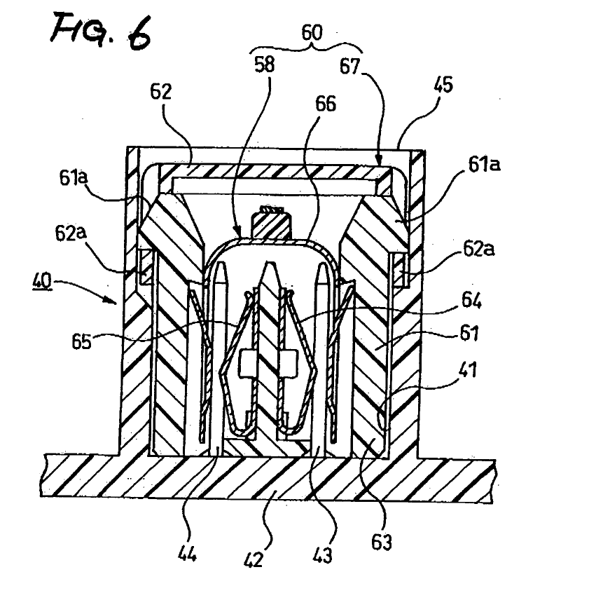

The fuse body 68, incorporated in the insulating housing 3 of the short plug-in fuse 1, is of an integral construction, and includes a pair of tab-receiving terminals 64 and 65 for connection respectively to the tab terminals 31 and 32 provided within a housing reception portion 34, and a fusible portion 66 interconnecting the tab-receiving terminals 64 and 65. This fuse body 68 is similar in construction to the fuse body 68 of the conventional short plug-in fuse 60 shown in. FIG. 6.

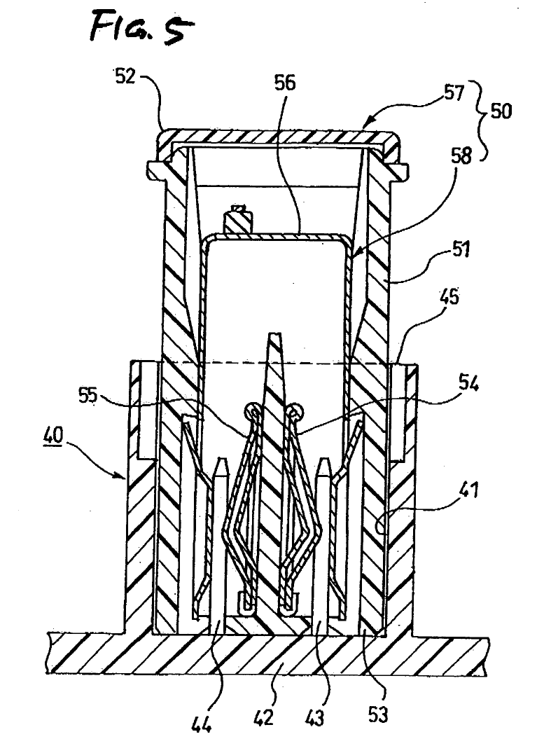

Although not shown in the drawings, the fuse body, incorporated in the insulating housing 13 of the long plug-in fuse 11, is similar in construction to the fuse body 58 of the conventional long plug-in fuse 50 shown in FIG. 5.

The (short/long) fuse cavity 23, 25 includes the housing reception portion 34, 35 having a tubular peripheral wall of a rectangular transverse cross-section, and the pair of tab terminals 31 and 32 (43 and 44) project into the interior of the housing reception portion 34, 35 through the bottom plate 36, and the upper end portion of the housing reception portion 34, 35 is open, and serves as a fuse insertion port 37, 39. The pair of tab terminals 31 and 32 (43 and 44) are connected serially to a circuit within a corresponding electrical part mounted on a car body.

The short fuse cavity 23 is set to a smaller fitting depth in corresponding relation to the short plug-in fuse 1, while the long fuse cavity 25 is set to a larger fitting depth in corresponding relation to the long plug-in fuse 11.

As shown in FIG. 1, the short fuse cavity 23 and the long fuse cavity 25 have the same length A and breadth B (which are frontage dimensions of the housing reception portion 34, 35), but have different height H1 and H2, respectively.

A pair of guide grooves 38 and 38 are formed in each of opposed inner side surfaces of the housing reception portion 34 of the short fuse cavity 23, and extend in the direction of fitting of the short plug-in fuse 1 into this cavity 23, and each pair of guide ribs 6 on the short plug-in fuse 1 can be fitted respectively into the corresponding pair of guide grooves 38.

These guide grooves 38 are not formed in the housing reception portion 35 of the long fuse cavity 35.

Therefore, even if trying to insert the short plug-in fuse 1 into the long fuse cavity 25 by mistake, the guide ribs 6 interfere with the fuse insertion port 39, so that the fuse 1 can not be inserted into the housing reception portion 35.

Therefore, the short plug-in fuse 1 is positively prevented from being erroneously inserted into the long fuse cavity 25.

Namely, in the plug-in fuse-mounting structure of this embodiment, the short fuse cavity 23, formed at the electric connection box 21, is somewhat different in the shape of the opening from the long fuse cavity 25 since the short fuse cavity 23 has the guide grooves 38. However, except the provision of the guide grooves 38, the short and long fuse cavities 23 and 25 are designed to have the same length A and breadth B (which are the basic dimensions of their transverse cross-sectional shape), so that these cavities maintain commonalities as fuse cavities, and therefore these fuse cavities never fail to be visually distinguished from the other cavities for other circuit elements (such as relay).

Even if trying to insert the short plug-in fuse 1 into the long fuse cavity 25 by mistake, the fuse 1 can not be inserted into the long fuse cavity 25 because of the interference of the guide ribs 6, and therefore the short plug-in fuse 1 is positively prevented from being erroneously fitted into the long fuse cavity 25.

Therefore, there will not be encountered a situation in which the short plug-in fuse 1 is erroneously fitted into the long fuse cavity 25, so that the top of this fuse 1 is completely received within the housing reception portion 35, and therefore there is no fear that this fuse can not be withdrawn from the housing reception portion, for example, when exchanging the fuse.

And besides, the guide ribs 6 are formed on the outer side surfaces of the short plug-in fuse 1, while the guide grooves 38 are formed in the inner side surfaces of the short fuse cavity 23, and therefore even when the fuse is formed into a small size, it is easy to confirm its inserting direction when inserting it into the corresponding short fuse cavity 23, and the short plug-in fuse 1 is prevented from being inserted in a wrong condition in which this fuse is turned 90 degrees.

Furthermore, when the guide ribs 6 are inserted respectively into the guide grooves 38, the guide ribs 6 are guided by the guide grooves 38, respectively, and therefore the gouging is prevented from developing during the insertion of the short plug-in fuse 1 into the short fuse cavity 23, and the smooth insertion of the fuse 1 is achieved.

Therefore, the connection terminals 31 and 32 and the fuse body 68 within the short fuse cavity 23 will not be deformed, and the efficiency of the fuse-mounting operation is enhanced.

In the plug-in fuse-mounting structure of the invention, the constructions of the guide grooves, guide rib and so on are not limited to those described in the above embodiment, and these portions can take various forms on the basis of the subject matter of the invention.

For example, in the above embodiment, the pair of guide ribs 6 and 6 are formed on each of the opposite outer side surfaces of the housing body portion 4 of the short plug-in fuse 1. However, the guide ribs 6 do not always need to be formed on these side surfaces, and the erroneous insertion prevention effect can be obtained when the guide ribs are formed on at least one side surface, and the number of the guide ribs may be arbitrary in so far as at least one guide rib is formed.

However, in the case of the above embodiment in which the pair of guide ribs 6 and 6 are formed on each of the parallel opposite outer side surfaces, recesses, each formed between the corresponding pair of guide ribs 6 and 6, can serve as good positioning means when bringing a withdrawal jig into retaining engagement with the fuse, and this withdrawal jig can be guided into such a position that its axis coincides with the axis of the fuse, and therefore the withdrawal jig can be pulled up in a stable condition.

In the above embodiment, for convenience sake, the short fuse cavity 23 and the long fuse cavity 25 are both provided on one electric connection box 21. However, even in the case of an electric connection box in which one type of fuse cavities are provided according to the kind of car on which the electric connection box is to be mounted, there is a possibility that a short plug-in fuse which is an off-specification product is erroneously inserted into a long fuse cavity, for example, during the maintenance. Even in such a case, the plug-in fuse-mounting structure of the invention is effective.

As described above, in the plug-in fuse-mounting structure of the present invention, the short fuse cavity, formed at the electric connection box, is somewhat different in the shape of the opening from the long fuse cavity since the short fuse cavity has the guide grooves. However, except the provision of the guide grooves, the short and long fuse cavities are designed to have the same length and breadth (which are the basic dimensions of their transverse cross-sectional shape), so that these cavities maintain commonalities as fuse cavities, and therefore these fuse cavities never fail to be visually distinguished from the other cavities for other circuit elements (such as relay).

Even if trying to insert the short plug-in fuse into the long fuse cavity by mistake, the short fuse can not be inserted into the long fuse cavity because of the interference of the guide ribs, and therefore the short plug-in fuse is positively prevented from being erroneously fitted into the long fuse cavity.

And besides, the guide ribs are formed on the outer side surfaces of the short plug-in fuse, while the guide grooves are formed in the inner side surfaces of the short fuse cavity, and therefore even when the fuse is formed into a small size, it is easy to confirm its inserting direction when inserting it into the corresponding short fuse cavity, and the short plug-in fuse is prevented from being inserted in a wrong condition in which this fuse is turned 90 degrees.

Furthermore, the short fuse cavity and the long fuse cavity are different from each other in transverse cross-sectional shape, and therefore the short fuse cavity and the long fuse cavity can be easily visually distinguished from each other even when the fuse is formed into a small size, and the efficiency of the fuse-mounting operation is enhanced.

What is claimed is:

1. A plug-in fuse-mounting structure comprising:
a plug-in fuse having an insulating housing and a fuse body received within the insulating housing; and
a fuse cavity into which said plug-in fuse is fitted and which includes connection terminals projecting from an inner bottom surface thereof,
wherein said fuse cavity has a small fitting depth in corresponding relation to a small height of said plug-in fuse, and at lease one guide groove is formed in an inner side surface of said fuse cavity so as to extend in a fitting direction of said plug-in fuse to said fuse cavity; and
a guide rib fitting into said guide groove is formed on an outer side surface of said plug-in fuse.

2. A plug-in fuse-mounting structure according to claim 1, in which a pair of said guide grooves are formed in each of opposed inner side surfaces of said fuse cavity, and a pair of said guide ribs are formed on each of opposite outer side surfaces of said plug-in fuse corresponding respectively to said opposed inner side surfaces.

3. A electrical connection box comprising:
a first plug-in fuse and a second plug-in fuse, wherein a height of the first plug-in fuse is smaller than a height of the second fuse and each of said first plug-in fuse and said second plug-in fuse has a common basic outer shape; and
a first fuse cavity and a second fuse cavity, wherein a depth of the first fuse cavity corresponds to the height of the first plug-in fuse and a depth of the second fuse cavity corresponds to the second plug-in fuse each of said first fuse cavity and said second fuse cavity has a basic cross-section;
wherein said fuse cavity has at lease one guide groove extends in a fitting direction of said plug-in fuse to said fuse cavity, and said first plug-in fuse has at least one guide rib for fitting into said guide groove.

4. An erroneous fitting prevention method for plural kinds of plug-in fuses to fuse cavities, comprising:
providing a first plug-in fuse and a second plug-in fuse, wherein a height of the first plug-in fuse is smaller than a height of the second fuse and each of said first plug-in fuse and said second plug-in fuse has a common basic outer shape;
providing a first fuse cavity and a second fuse cavity, wherein a depth of the first fuse cavity corresponds to the height of the first plug-in fuse and a depth of the second fuse cavity corresponds to the second plug-in fuse each of said first fuse cavity and said second fuse cavity has a basic cross-section; and
fitting said first plug-in fuse into said first cavity;
wherein said first fuse cavity has at lease one guide groove extends in a fitting direction of said plug-in fuse to said fuse cavity, and said first plug-in fuse has at least one guide rib for fitting into said guide groove, so that said first plug-in fuse is selectively fitted by said first fuse cavity and while said first plug-in fuse is not allowed to be fitted into said second fuse cavity.
